(19) United States
(12) Patent Application Publication
(10) Pub. No.: US 2021/0354063 A1
(43) Pub. Date: Nov. 18, 2021

(54) Convoluted Dual Density Filter Material

(71) Applicant: Hobbs Bonded Fibers NA, LLC, Waco, TX (US)

(72) Inventor: Karl VanBecelaere, Waco, TX (US)

(21) Appl. No.: 17/321,404

(22) Filed: May 15, 2021

Related U.S. Application Data
(60) Provisional application No. 63/025,722, filed on May 15, 2020.

(51) Int. Cl. B01D 39/16; D04H 1/435

(52) U.S. Cl. CPC B01D 39/163; D04H 1/435; D10B 2505/04; D10B 2331/04; D10B 2403/011

(57) ABSTRACT

A dual layer filter material for separating fluid or particulates from flowing air streams that is comprised of connected layers of nonwoven batting with one layer having a convoluted surface.

### PRIORITY CLAIM

This application claims priority to U.S. Provisional Application No. 63/025,722 filed on May 15, 2020, which is hereby incorporated by reference.

### TECHNICAL FIELD OF THE INVENTION

The present invention is generally related to filter materials for use in mixed air and fluid streams or mixed air and particulate streams, and more specifically to various non-woven battings used for removal of fluids and particulates from air streams.

### BACKGROUND OF THE INVENTION

Various filter media are used to separate particulate materials and fluids from air streams. The efficiency of filter materials in removing liquids and particulate matter from air streams, the pressure drop and flow rate of the air stream as it moves through the filter media, and the useful lifetime of such filter media when used for these separation purposes are all critical factors in choosing an appropriate material or combination of materials to use as filter media for removal of fluids or particulates from air streams. Generally, the useful lifetime of such filters that are used to separate or remove liquid or particulates from flowing airstreams is determined by the total amount of fluid or particulate matter that can be absorbed or retained by the filter material(s) before the flow rate of the air stream passing through the filter that is comprised of the filter material(s) is substantially decreased to the point that the filter must be removed and replaced with a new filter that is not clogged with previously absorbed, adhered, or retained liquid or particulate matter.

Physical barrier filtration involves physical separation of fluids or particulates from an air stream using a filter comprised of a material or a combination of multiple materials that physically block the fluid or particulate matter that is carried by, or entrained within, the flowing stream of air while simultaneously allowing the stream of air to flow through the material(s). In other words, during physical barrier filtration, the fluid and/or particulates are removed by the material(s) of a filter while the air stream that is now-devoid of the fluid and/or particulates flows through the material(s) in an unimpeded or relatively unimpeded manner. The material(s) used to accomplish physical barrier separation are porous in nature, and they allow flowing air to pass through the openings (or “pores”) within the material(s) that exist between fibers, while the fluid(s) and/or particulates that are initially carried by, or are initially entrained within, the flowing air, strike the material(s) of the filter and are physically blocked by those material(s).

The physical blocking of the fluid(s) and/or particulates that are initially carried by or entrained within the flowing air stream can potentially occur in one or more than one way. For instance, some of the fluid(s) and/or particulates that are initially part of the flowing air stream may be deflected by, or partially deflected by, impact with the material(s) of the filter as they come into contact with a surface of the filter. Alternatively, the fluid(s) and/or particulates that are initially part of the air stream as they come into contact with a surface of the material(s) of the filter may become absorbed by or may adhere to portions of the material(s). Additionally, and especially, but not exclusively, with regard to dry particulate matter, the fluid(s) or particulates may be retained by or on the filter material(s), including but not limited to being retained on the surface of the filter material(s) or becoming embedded or captured within the material(s) of the filter.

Sheets of high loft, non-woven fibrous material have been used for physical barrier filtration in the past, such as with filtration for paint booth exhaust systems in which air filters serve as paint arrestors wherein paint droplets in the air stream to be filtered will come into contact with the surface of the filter media and are absorbed by, or adhere to, the filter materials and are retained thereon, while the air stream passes through the pores in the fibrous filter material. In such scenarios, the paint droplets may be absorbed by, may adhere to, or may otherwise be retained on or within the fibrous material of the filter. In conventional arrangements, the filter is comprised of a single layer of nonwoven fibrous material that is flat and has a flat front surface and a flat back surface (where the terms “front” and “back” may be used interchangeably with “top” and “bottom” depending upon positioning of the filter).

Filters comprised of single layer sheets of non-woven fibrous material with flat surfaces have proven to be relatively unsatisfactory in terms of useful lifetime because they become clogged with fluid or particulate matter relatively quickly during use. This is particularly true when the filters are used as paint arrestors in industrial paint booths. Although various other arrangements have been tried, thus far there is has not been a satisfactory solution that provides a relatively long-life filter for separation of fluid and particulate materials from flowing air streams.

### SUMMARY OF THE INVENTION

The present invention is a dual layer filter material that provides a relatively long useful life that is comprised of two layers of non-woven batting material that are adhered together to form the dual layer filter material. The two layers of non-woven batting can be described, respectively, as a first stage and a second stage of the disclosed filter material. The first stage and the second stage are adhered together to combine them in order to form the overall dual layer filter material, such as by using adhesive glue to adhere the two layers/stages together.

The first stage of the filter material is a layer that has a convoluted top surface comprised of peaks and valleys (the valleys could also be described as “troughs” since the convoluted surface of the first stage has a wave-like pattern). In most embodiments, the bottom surface of the first stage will have a generally flat planar surface that will be adhered to the top surface of the second stage of the filter material during a manufacturing process in order to arrive at the overall dual layer filter material that is hereby disclosed. The first stage is comprised of a mixture of polyester fibers and at least ten percent (10%) low melt polyester fibers, all of which is saturated with resin. In a preferred embodiment, the resin is a pure acrylic resin, such as, for instance, P-2893 from ONA Polymers. At least a majority of the polyester fibers in the first stage have a linear density of at least 25 denier or greater.

The peaks of the convoluted top surface of the first stage rise vertically above the valleys of the convoluted surface. The height (or thickness) of the peaks of the convoluted top surface of the first stage as measured from the bottom surface of the first stage to the top of the peaks is at least double, and preferably at least triple, the height (or thickness) of the valleys of the convoluted top surface of the first stage as measured from the bottom surface of the first stage to the top of the valleys. This difference in heights (or thicknesses) between the peaks and valleys of the convoluted top surface of the first stage will become easier to understand with reference to the patent drawings that are described herein.

The second stage of the filter material is a backing layer that is a relatively denser layer of nonwoven batting material, but is comprised of polyester fibers wherein the fibers themselves have less linear density than those contained within the first stage, with the fibers in the second stage being between 3 denier and 25 denier. In a preferred embodiment, the polyester fibers in the second stage are no greater than 15 denier. The second stage is also saturated with resin. In a preferred embodiment the resin is a pure acrylic resin, such as P-2893 from ONA Polymers. N most embodiments, the second stage will have a generally flat top surface and a generally flat bottom surface. During a manufacturing process, the top surface of the second stage will be adhered to the bottom surface of the first stage.

In order to form the first stage, regular polyester fibers, in which at least a majority of the fibers are 25 denier or greater, are mixed together with low melt polyester fibers having a melting point in the range of 110° C.-200° C. such that the total resulting mixture has no less than 10% low melt polyester fibers, and no greater than 50% low melt polyester. That mixture is then saturated with resin and formed into an initial sheet material that is cured. After curing, the initial sheet material is then cut into two separate intermediate sheets using a cutter device such that each of the resulting intermediate sheets will have a convoluted surface on one side and a generally flat planar surface on the other side, as described previously for the first stage. Heat is applied to the convoluted surface, either during the cutting process or afterward, and this causes the low melt polyester at the level of the convoluted surface to melt and bind together. However, the convoluted surface and its peaks and valleys retain inherent porosity when the low melt polyester fibers are melted because the low melt polyester only surrounds the connecting points of the fibers when it melts.

In a preferred embodiment, the resin used in the first stage is a 100% acrylic resin.

The second stage is formed by mixing polyester fibers of 3 denier-25 denier with resin and then processing that mixture into a dense sheet material that is cured. In a preferred embodiment, all of the fibers are no more than 15 denier and the resin is a 100% acrylic resin. Once the mixing of fibers and resin occurs and a curing process has been completed to cure the resin, the second stage will then be adhered to the bottom surface of the first stage in order to form the disclosed dual layer filter material. Adhering the denser second stage to the bottom surface of the less dense first stage may be accomplished by using low melt point film between the layers and adding heat, or by sewing or stitching the two stages together, or possibly by needle pun chi the two layers for mechanical connection, but in a preferred embodiment, the two stages are adhered to each other by using glue adhesive. This yields a dual layer filter material with a top, less dense, convoluted layer and a bottom, more dense layer, that can be used for physical barrier filtration of air streams containing fluid or particulate materials.

The dual layer filter material comprised of the combination of the two stages that are adhered together can be used to filter fluid or particulate matter out of flowing air streams, and it provides a relatively long useful life when compared to the useful life of conventional filter materials. While the inventor does not wish to be bound by theory with regard to why the convoluted dual layer filter material provides a longer useful life compared to conventional filter materials, the inventor believes that the reason probably has to do with increased surface area and is also probably due to which parts of the convoluted surface of the top layer/first stage are first impacted by the air stream containing the fluid or particulate matter, i.e., the location where the fluid or particulates will first come into contact with the peaks and valleys provided by the convoluted top surface of the less dense first stage of the filter material. The convoluted top surface of the first stage with its peaks and valleys serves to drastically increase the total surface area available for physical filtration of the air stream as compared to the amount of surface area that would be provided by a conventional, simple, planar surface. Further, because the air stream can generally be considered a linear flow when it initially conies into contact with the convoluted top surface of the first stage, the fluid droplets or particulate matter will impact and adhere to, or become absorbed by, the fibers located at the tops and at the sloped sides of the peaks without clogging or blocking the porous openings that exist between the ends or edges of the fibers that are located along the sloped sides of the peaks. Further, due to the larger denier of the polyester fibers in the first stage and the lower density of the first stage, the first stage is relatively porous and allows air to flow through while the fibers serve as a physical barrier to the fluid droplets or particulates and prevent them from flowing through. The second stage of the filter material is more dense and has finer fibers but also is inherently porous because it has openings throughout (that are smaller than the openings of the first stage) such that the air stream flows through, but smaller droplets of fluid or particulates with smaller diameter that might not be blocked by the first stage are blocked/trapped within the second stage. An understanding of the invention may be enhanced by a discussion of the attached drawings that are discussed below.

While both stages of the dual density filter material are comprised of polyester fibers and resin, the invention could also be practiced using polypropylene, rayon, or fiberglass fibers. Polyester fibers are used in a preferred embodiment. It should further be noted that this specification distinguishes between regular polyester fibers and low-melt polyester fibers as discussed above, and this is also true in the appended claims.

While the primary embodiment of the invention involves a dual density filter material comprised of a less dense first stage and a more dense second stage that are separately cured and then adhered together, another, different embodiment is also envisioned by the inventor in which there would be a dual feed system with three cards that could be used to make a bait with a high density bottom layer and high density top layer (both of which would be the same as the second stage described above) and a lower density middle layer with a convoluted surface (that is the same as the first stage described above) that is sandwiched between the top layer and the bottom layer.

### DESCRIPTION OF THE DRAWINGS

FIG. 1 is a perspective view of the dual layer filter material 10. FIG. 1 illustrates that the dual layer filter material 10 is comprised of a first stage 30 and a second stage 40 that are joined by an adhesive layer 20. As can be appreciated from FIG. 1, the first stage 30 has a convoluted top surface that has the appearance of a repeated wave-like pattern comprised of a multiplicity of “peaks” and “valleys.”

FIG. 2 is a close-up detail view of the dual layer filter material 10 that is a close-up view of the section of the dual later filter material 10 in the circle 2 that appears in FIG. 1. As can be seen in more detail in FIG. 2, the first stage 30 has a convoluted top surface comprised of a multiplicity of peaks 32 and valleys 31 that are arranged in a wave-like pattern.

FIG. 3 is a side view of only the first stage 30. As can be seen in reference to FIG. 3, the convoluted top surface of the first stage 30 is comprised of a multiplicity of peaks 32 and valleys 31. The peaks 32 and valleys 31 rise above the first stage bottom surface 36, which is the bottom surface of the first stage 30, to a respective peak height (H) and a respective valley height (h), wherein the peak height H is greater than the valley height h. In most embodiments, the peak height H will be at least double the valley height h, and as shown in FIG. 3, in a preferred embodiment the peak height is three or more times the valley height h, as measured from the first stage bottom surface 36.

FIG. 4 is a side view demonstrating one part of a manufacturing process that may be used during the manufacturing of the first stage 30. As illustrated, the initial first stage material after curing 50 may be run through rollers (R) and cut by a cutter (C) into two separate sheets of first stage 30 material, each having a convoluted top surface as a result of the action of the cutter C. The cutter C may also be heated to the extent necessary to melt the low melt polyester fibers that are contained within the first stage material after curing 50 and that are ultimately located at the level of the peaks 32 and valleys 31 of the convoluted top surface after cutting.

FIG. 5 is a side view of the initial first stage material after curing 50 as it might appear immediately after a cutter C device or other similar tool has cut it into two separate sheets of the first stage 30 material along a wave-like cutting line 37, but immediately before the two sheets are pulled apart during the manufacturing process. Again, what is illustrated is a preferred embodiment in which the peak height H exceeds the valley height h for both of the sheets of first stage 30 material that will ultimately be pulled apart during manufacturing and then each will have its bottom surface (that is generally flat in most embodiments) adhered to a surface of second stage material 40.

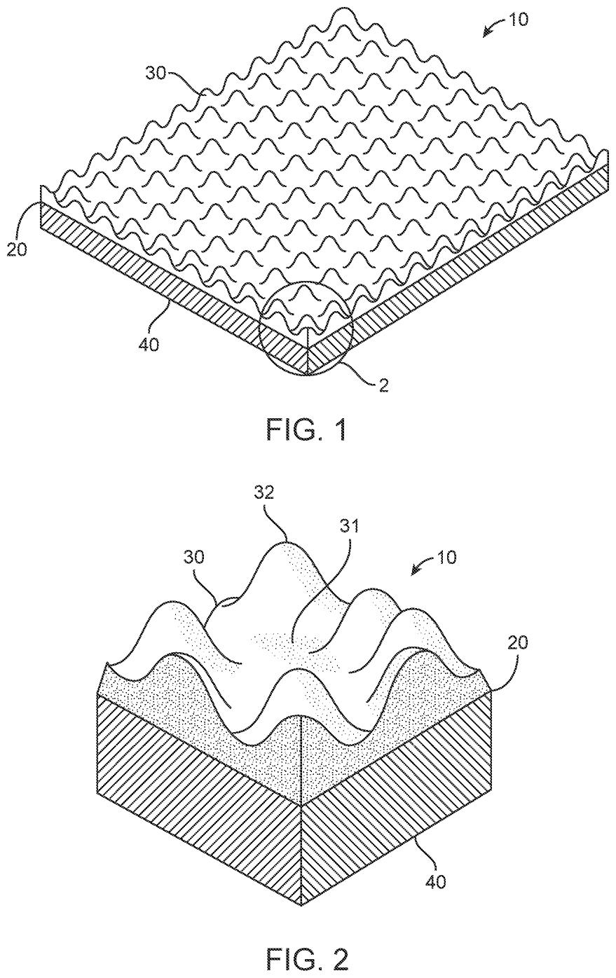

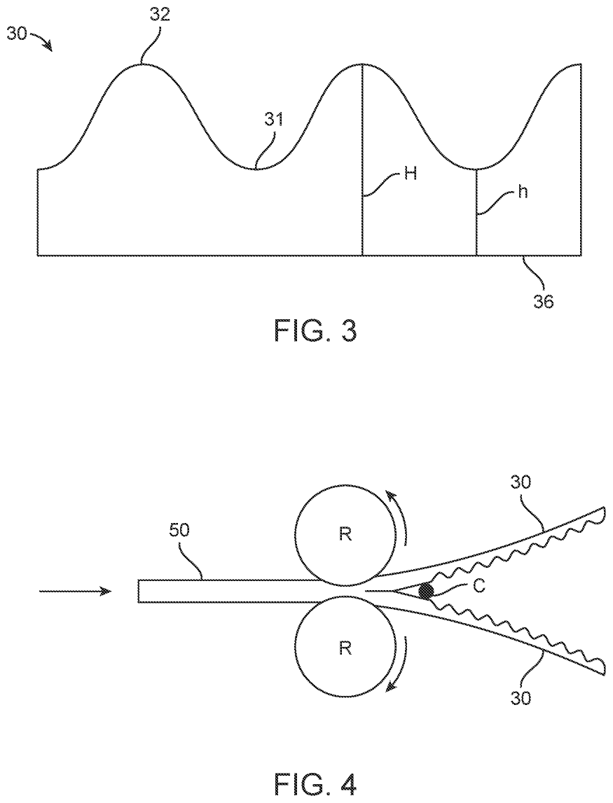

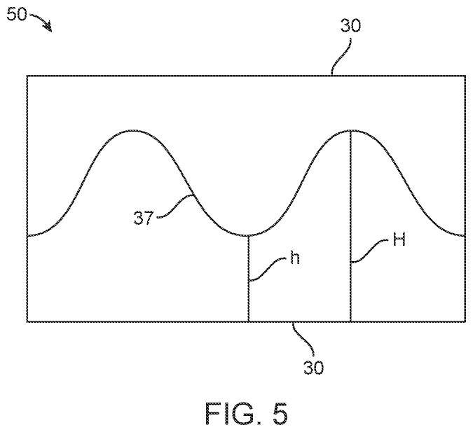

As discussed above, when the first stage bottom surface 36 is physically attached with, or adhered to, a surface of the second stage 40, this may be done by using low melt point film between the layers and adding heat, or by sewing or stitching the two stages together, or possibly by needle punching the two layers for mechanical connection, but as also explained, in a preferred embodiment, the two stages are adhered to each other by using glue adhesive. It should be appreciated that regardless of the manner in which the first stage and second stage are physically connected to each other to form the dual layer filter material, there is at least some continuity of porosity between the two stages/layers at the location where they interface and are adhered together. Clearly this is the case in instances of mechanical connection such as with needling or sewing, but this would also be true for adhering the two stages/layers together, such as with use of low melt point film and application of heat or with gluing of the two stages because even though the fibers of each stage at the location of their interface and adhesion would be adhered to each other, there would also be overlap or partial overlap between the pores that exist between the fibers of each stage at the location of interface/adhesion between the stages/layers. Thus, there is at least some continuity of porosity between the stages/layers, and of course if there were not, there would be no air flow through the filter material, which is not the case.

The terms “fluid” and “liquid” are used synonymously in this specification and have the same meaning and are treated as interchangeable terms. Likewise, the terms “air stream” and “stream of air” and “flowing air” are used synonymously in this specification and have the same meaning and are treated as interchangeable terms. Furthermore, it is understood that the term “air” as used in this specification has its plain and ordinary meaning. Air is a mixture of primarily Nitrogen and Oxygen, with much smaller amounts of other gases, such as Carbon Dioxide, Neon, and Hydrogen, etc.

The embodiments and other features, aspects, and advantages of the present invention may be best understood and appreciated with reference to the drawings, descriptions, and claims. Where used in the various figures of the drawings, the same numerals designate the same or similar parts. Furthermore, When the terms “top”, “bottom”, “front”, “back”, “first”, “second”, “third”, “end”, “ends”, “side”, “sides”, “edge”, “edges” and similar terms are used herein, it should be understood that, unless otherwise specifically stated or otherwise made specifically clear by context, these terms have reference only to the structure shown in the drawings as it would appear to a person viewing the drawings, and such terms are utilized in order to facilitate describing the invention and in order to facilitate a better understanding of the invention.

Although the invention has been described with reference to specific embodiments, this description is not meant to be construed in a limiting sense. Various modifications of the disclosed embodiments, as well as alternative embodiments of the invention, will be apparent to persons skilled in the art upon reference to the description of the invention that is provided in this specification. It is, therefore, contemplated that the appended claims will cover such modifications and variations that fall within the scope of the invention.

What I claim is:

1. A dual layer filter material for separation of fluid or particulates from air streams comprised of:
a first stage that is a non-woven batting comprised of regular polyester fibers and low-melt polyester fibers;
a second stage that is a non-woven batting comprised of regular polyester fibers and low-melt polyester fibers;
wherein a surface of the first stage and a surface of the second stage are connected to each other.

2. The filter material of claim 1, wherein the first stage has a convoluted surface comprised Of a multiplicity of peaks and valleys.

3. The filter material of claim 1, wherein the connection between the first stage and second stage is accomplished by a glue adhesive.

4. The filter material of claim 1, wherein the polyester fibers of the first stage that are not low-melt polyester fibers are at least 25 denier.

5. The filter material of claim 1, wherein the polyester fibers of the second stage that are not low-melt polyester fibers are no greater than 15 denier.

6. The filter material of claim 2, wherein the first stage also has a generally flat surface opposite its convoluted surface.

7. The filter material of claim 6, wherein the height of the peaks of the convoluted surface above the generally flat surface exceeds the height of the valleys of the convoluted surface above the generally flat surface.

8. The filter material of claim 7, wherein the height of the peaks of the convoluted surface above the generally flat surface is at least two times greater than the height of the valleys of the convoluted surface above the generally flat surface.

9. The filter material of claim 1, wherein both the first stage and second stage are porous.

10. The filter material of claim 1, wherein both the first stage and second stage are impregnated with resin and that resin has been cured.

11. The filter material of claim 10, wherein the resin is a pure acrylic resin.

12. A dual layer filter material for separation of fluid or particulates from air streams that is comprised of:
a porous first layer that has a top surface and a bottom surface and that is comprised of polyester fibers, low-melt polyester fibers, and resin;
a porous second layer that has a top surface and a bottom surface and that is comprised of polyester fibers, low-melt polyester fibers, and resin;
wherein the bottom surface of the first layer is adhered to the top surface of the second layer, and the resin in both layers is cured.

13. The filter material of claim 12, wherein the top surface of the first layer features a multiplicity of peaks and valleys.

14. The filter material of claim 13, wherein the distance between the tops of the peaks and the bottom surface of the first layer is greater than distance between the tops of the valleys and the bottom surface of the first layer.

15. The filter material of claim 14, wherein the distance between the tops of the peaks and the bottom surface of the first layer is at least double the distance between the tops of the valleys and the bottom surface of the first layer.

16. The filter material of claim 12, wherein a majority of the polyester fibers of the first layer are 25 denier or greater.

17. The filter material of claim 12, wherein the polyester fibers of the second layer are no greater than 15 denier.

18. The filter material of claim 12, wherein the resin is pure acrylic resin.

19. The filter material of claim 12, wherein the first layer and second layer are adhered together by a glue adhesive.

20. A dual layer filter material for separation of fluid or particulates from air streams that is comprised of:
a first stage that is a porous non-woven batting comprised of polyester fibers, low-melt polyester fibers, and acrylic resin, wherein a majority of the polyester fibers are 25 denier or greater and the resin has been cured;
a second stage that is a porous non-woven batting comprised of polyester fibers, low-melt polyester fibers, and acrylic resin, wherein the polyester fibers are no greater than 15 denier and the resin has been cured;
wherein the first stage has a planar bottom surface and a convoluted top surface comprised of a multiplicity of peaks and valleys;
wherein the second stage has a planar top surface and a planar bottom surface;
an adhesive layer connecting the planar bottom surface of the first stage and the planar top surface of the second stage.
